(19) United States
(12) Patent Application Publication
(10) Pub. No.: US 2007/0065756 A1
(43) Pub. Date: Mar. 22, 2007

(54) HIGH SENSITIVITY ELECTRON BEAM RESIST PROCESSING

(75) Inventors: Eric Lavallee, Rock Forest (CA); Bertrand Takam Mangoua, Sherbrooke (CA)

Correspondence Address: FULBRIGHT & JAWORSKI L.L.P., 600 CONGRESS AVE., SUITE 2400, AUSTIN, TX, 78701, US

(73) Assignee: Quantiscript Inc., Universite de Sherbrooke, Sherbrooke (CA)

(21) Appl. No.: 11/229,353

(22) Filed: Sep. 16, 2005

(51) Int. Cl. G03C 5/00

(52) U.S. Cl. 430/296; 430/942

(57) ABSTRACT

A process for producing a pattern in a radiation sensitive fluoropolymer resist, comprises depositing a layer of the radiation sensitive fluoropolymer resist on a face of a substrate. The radiation sensitive fluoropolymer resist is exposed to an electron beam to define the pattern, the resist then having an exposed fluoropolymer resist area defining the pattern and an unexposed fluoropolymer resist area. The exposed fluoropolymer resist area is finally removed by contacting the radiation sensitive fluoropolymer resist with an alkaline polar aprotic solvent system leaving only the unexposed fluoropolymer resist area on the substrate.

### FIELD OF THE INVENTION

The present invention relates to lithographic patterning. More specifically, the present invention relates to electron beam resist patterning.

### BACKGROUND OF THE INVENTION

The fabrication of semiconductor devices calls upon the use of high resolution and high sensitivity electron beam resists. Such electron beam resists constitute an important aspect in the manufacture of photomasks used in conventional lithography processes as well as for the manufacture of these devices using direct electron beam patterning. Very large scale integration devices (VLSI) and ultra-high scale integration devices (UHSI) require high resolution features as well as the ability to pattern these features at a very high speed. These high resolution requirements are expressed by the microelectronic industry through a roadmap, calling for 65 nm size features by 2007 and for 22 nm size features by 2016.

Although conventional photolithography typically uses a 4× reduction factor between the photomask and the patterned wafers using a series of lenses in the exposure system, the photolithography exposure tools currently used in the industry use a 193 nm wavelength to transfer the patterns. The requirements for sub-wavelength patterning imply that even though a 4× reduction factor is used, higher resolution features are required on the photomask to compensate for sub-wavelength interference effects of the light source. In many cases, the additional resolution features require a resolution equivalent to the size of the final features to be printed. This in turn requires photomasks to be patterned using electron beam lithography with sub-90 nm feature sizes.

Alternative patterning techniques such as direct patterning by electron beam or shaped electron beam have been studied as potential replacements to conventional photolithography. The wavelength of electrons being much smaller then the wavelength of photons, sub-wavelength interference effects are not an issue. A further alternative is the use of imprint lithography wherein relief structure templates are directly embossed into a soft material as described in U.S. Pat. No. 5,772,905 granted to Chou on Jun. 30, 1998. In the case of imprint lithography, there is a need to pattern the relief structure templates using electron beam lithography in order to create features equal in size to the features on the devices. Therefore, whether the device fabrication technique is conventional lithography, imprint lithography or direct electron beam lithography, sub-90 nm electron beam lithography is required, either to fabricate the photomasks or the templates, or to directly pattern the devices. Moreover, in all cases, a high sensitivity of the resist is required in order to meet the throughput requirements of the industry. Furthermore, in several cases a positive tone resist is required.

Polymeric electron beam sensitive layers comprising polymers having recurrent acid labile groups which undergo acidolysis to effect a change in solubility of the polymer and a photoinitiator which generates an acid upon exposure to radiation have been previously described in U.S. Pat. No. 4,491,628 granted to Ito et al., on Jan. 1, 1985. Both the positive and negative working of the radiation sensitive layer was demonstrated by Ito et al., depending on the exposure and development conditions. However, the dissolution differentiation mechanism involved with these systems has been demonstrated to possess very low threshold exposure doses for the reaction to occur. Moreover, the use of photoinitiators such as described by Ito et al. provides for a certain mobility of the generated acids within the polymeric matrix, such that the fabrication of very high resolution features, required in the deep sub-90 nm regime, are essentially prohibited.

Several other positive electron-sensitive layers such as poly(methyl methacrylate) and poly(butene-1-sulfone), which, under electron beam exposure undergo crosslinking or chain scission, have been disclosed in U.S. Pat. No. 4,454,200 granted to Belliott on Jun. 12, 1984. However, these systems typically suffer from poor resistance to the chemical processes used in the industry to transfer the pattern from the resist to the underlying material, such as to pattern gates (i.e. transistor gates) or via-holes in integrated circuits.

The use of silicon comprising compounds for depositing radiation sensitive films having sufficient resistance to the chemical processes involved in pattern transfer have been investigated as previously described in U.S. Pat. No. 6,652,922 granted to Forester et al., on Nov. 25, 2003. However, these films are not satisfactory in terms of threshold exposure doses, as the films are not sufficiently sensitive to radiation.

The use of plasma-deposited fluoropolymer-organosilicon mixtures for preparing both negative and positive radiation sensitive multilayer films has been previously described in U.S. Pat. No. 4,560,61 granted to Kokaku et al., on Dec. 24, 1985. However, only the plasma deposited upper layer, which was formed of a mixture comprising an organosilicon and a halogen containing substrate, was sensitive to radiation. The use of plasma assisted development requires equipment which is different from what is currently used in the industry for photomask development such as spin-spray or puddle liquid development systems.

Fluoropolymers have been demonstrated as radiation sensitive layers with sensitivity to the 193 nm and 157 nm wavelengths as used in conventional UV lithography, as well as having good resistance to the chemical processes involved in pattern transfer [U.S. Pat. No. 6,884,564 granted to Feiring et al., on Apr. 26, 2005; U.S. Pat. No. 6,787,286 granted to Szmanda et al., on Sep. 7, 2004; and U.S. Pat. No. 6,916,590 granted to Kaneko et al., on Jul. 12, 2005]. Moreover, the use of fluoropolymers comprising recurrent acid labile groups in patternable resists for electron beam exposure have also been described [U.S. Pat. No. 6,866,983 granted to Hatakeyama et al., on Mar. 15, 2005; U.S. Pat. No. 6,790,591 granted to Harada et al., on Sep. 14, 2004; and U.S. Pat. No. 6,610,465 issued to Rahman et al., on Aug. 26, 2003].

A further approach for patterning radiation sensitive layers was disclosed in U.S. Pat. No. 6,509,138 granted to Gleason et al., on Jan. 21, 2003]. The patterning approach involves the use of radiation to expose fluoropolymer layers deposited using chemical vapor deposition to form a pattern, followed by developing the pattern using a supercritical fluid (SCF) as a developer.

Highly sensitive positive photoresist compositions made by combining a polymeric material having functional groups pendent thereto contributing to the solubility of the polymeric material in alkaline developers, and wherein a portion of the functional groups are protected with masking or acid labile groups which inhibit the solubility of the polymer, with a photo-initiator capable of generating a strong acid upon radiolysis are disclosed in U.S. Pat. No. 6,051,659 granted to Merritt et al., on Apr. 18, 2000.

Finally, the use of a plasma polymerized fluoropolymer layer as a negative electron beam resist for patterning was disclosed in U.S. Pat. No. 6,855,646 granted to Awad et al., on Feb. 15, 2005. An alkaline solution was used to develop the patterned face.

There thus remains a need for a method of patterning a fluoropolymer layer (or film) providing for high resolution structures having good resistance to pattern transfer processes.

The present invention seeks to meet these and other needs.

The present description refers to a number of documents, the content of which is herein incorporated by reference in their entirety.

### SUMMARY OF THE INVENTION

The present invention relates to a process for producing a pattern in a radiation sensitive fluoropolymer resist, comprising depositing a layer of the radiation sensitive fluoropolymer resist on a face of a substrate; exposing the radiation sensitive fluoropolymer resist to an electron beam to define the pattern, the resist then having an exposed fluoropolymer resist area defining the pattern and an unexposed fluoropolymer resist area; and removing the exposed fluoropolymer resist area by contacting the radiation sensitive fluoropolymer resist with an alkaline polar aprotic solvent system leaving only the unexposed fluoropolymer resist area on the substrate.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing such as “contain” and “contains”) are inclusive or open-ended and do not exclude additional, unrecited elements or method steps.

The term “about” is used to indicate that a value includes an inherent variation for the device or the method being employed to determine the value.

The term “polar aprotic solvent”, as used herein, is understood a being a polar solvent having dipoles due to polar bonds, which do not have H-atoms capable of being donated into an H-bond (i.e. they do not have a hydrogen attached to an electronegative atom), and in which anions remains essentially un-solvated. Suitable polar aprotic solvents are disclosed, e.g., in Aldrich Handbook of Fine Chemicals and Laboratory Equipment, Milwaukee, Wis. (2000). Examples of suitable polar aprotic solvents include polar aprotic solvents having an amide group, an ester group, a carbonate group, a ketone, an ether, a sulfonyl group, or a combination thereof. Polar aprotic solvents can be DMSO, DMF, DMA, CH₃CN, CH₃NO₂, HMPA, 1-methyl-2-pyrrolidinone, N,N-dimethylpropionamide, N,N-dimethylacetamide, N,N-diethylacetamide, propylene carbonate, acetone or any combination thereof.

The foregoing and other objects, features and advantages of the present invention will become apparent from the following non-restrictive detailed description. It should be understood, however, that the detailed description and the specific examples, while indicating illustrative embodiments of the invention, are given by way of illustration only, since various changes and modifications within the spirit and scope of the invention will become apparent to those skilled in the art from this detailed description.

### BRIEF DESCRIPTION OF THE DRAWINGS

Having thus generally described the invention, reference will now be made to the accompanying drawings, showing by way of illustration a preferred embodiment thereof, and in which:

FIG. 1 is a side, elevational view of a substrate on which a layer (or film) of fluoropolymer has been deposited.

FIG. 2 is a side, elevational view of the substrate and layer (or film) of fluoropolymer of FIG. 1, showing exposure of the layer (or film) of fluoropolymer to an electron beam resulting in the fluoropolymer undergoing changes in molecular structure, the electron beam being a controlled focus or shaped electron beam.

FIG. 3 is a side, elevational view of the substrate and layer (or film) of fluoropolymer of FIG. 1, showing a pattern that has been formed in the layer (or film) of fluoropolymer by means of the electron beam and exposure of the pattern to a solution of alkaline salts.

FIG. 4 is a side, elevational view of the substrate and layer (or film) of fluoropolymer of FIG. 1, in which the area of the fluoropolymer layer (or film) exposed to the electron beam has been etched away such as by exposure to a solution of alkaline salts.

FIG. 5a is a side, elevational view of a substrate on which layers (or films) of chromium and fluoropolymer have been deposited.

FIG. 5b is a side, elevational view of the substrate and layers (or films) of chromium and fluoropolymer of FIG. 1, showing exposure of the layer (or film) of fluoropolymer to an electron beam to form a pattern.

FIG. 5c is a side, elevational view of the substrate and layers (or films) of chromium and fluoropolymer of FIG. 1, showing the pattern of FIG. 5b that has been etched away from the layer (or film) of fluoropolymer such as by exposure of the pattern to a solution of alkaline salts.

FIG. 5d is a side, elevational view of the substrate and layers (or films) of chromium and fluoropolymer of FIG. 1, in which an exposed area of the chromium layer (or film) has been etched away.

FIG. 5e is a side, elevational view of the substrate and layer (or film) of chromium in which the layer (or film) of fluoropolymer of FIG. 5d has been totally etched away.

### DETAILED DESCRIPTION OF THE ILLUSTRATIVE EMBODIMENTS

With reference to the accompanying drawings, the illustrative embodiments of the present invention will now be described.

The illustrative embodiments of the present invention relate to a process for patterning radiation sensitive fluoropolymer layers (or films) having high sensitivity to electron beam(s), and having good resistance to chemical transfer processes.

Among many other applications, this process can be used in the fabrication of, for example, photomasks for conventional UV lithography.

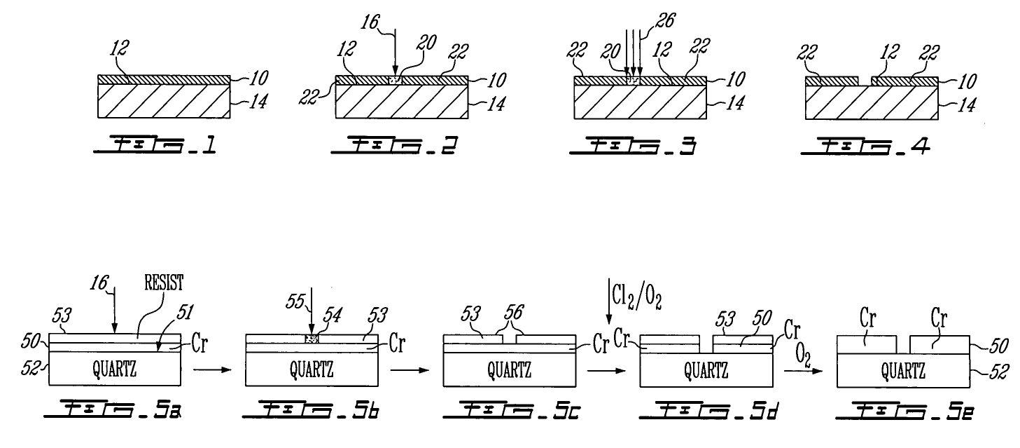

An illustrative embodiment of the present invention is illustrated in the appended FIGS. 1-4. An area of a layer (or film) 10 of a radiation sensitive fluoropolymer, deposited on the face 12 of a substrate 14 is exposed to a controlled electron beam 16 to define (or write) a pattern 20. Following exposure to the electron beam 16, the layer 10 comprises an exposed resist area or areas defining the pattern 20 and an unexposed resist area or areas such as 22 (FIGS. 2 and 3). The pattern 20 in the layer (or film) 10 of the radiation sensitive fluoropolymer can be removed following treatment with a solution of alkaline salts 26 (FIG. 3). The pattern 20 is thus removed to leave on the face 12 of the substrate 14 only the unexposed resist area(s) 22 (FIG. 4).

More specifically, exposure of the layer (or film) 10 of radiation sensitive fluoropolymer to the electron beam 16 induces changes in the molecular structure of the radiation sensitive fluoropolymer resulting in the formation of the pattern 20. The changes in the molecular structure of the radiation sensitive fluoropolymer make it susceptible to dissolution in a solution of alkaline salts 26 (FIG. 3) with the concomitant removal of the pattern 20.

The layer (or film) 10 of fluoropolymer can be deposited on the face 12 of a substrate 14 using various methods, including plasma assisted deposition or chemical vapor deposition. Both methods of deposition call upon the use of a gas selected from the group consisting of CF₄, C₂F₄, C₂F₆, C₃F₈, C₄F₈, CHF₃, CH₂F₂ C₃F₆ and a combination of any of these gases with a second gas selected from the group consisting of CH₄, H₂, He, N₂ and O₂ under electric excitation conditions. These conditions produce reactive species that react together to produce a non-volatile layer of fluoropolymer on the surface of the substrate 14. CH₄ and H₂ may react with the fluorine containing gases to the form the fluoropolymer while N₂ and He are mainly used to reduce the energy of the ions in the plasma. O₂ is mainly used to shorten the length of the polymeric chains formed by deposition. Non-limiting examples of fluoropolymers that can be deposited as a layer (or film) 10 on the face 12 of a substrate 14 are selected from the group consisting of poly-fluorotetraethylene, cross-linked poly-fluorotetraethylene, polyvinyl fluoride, cross-linked polyvinyl fluoride, polyvinylidene fluoride, cross-linked polyvinylidene fluoride, poly-perfluoroalkoxy fluorocarbon, cross-linked poly-perfluoroalkoxy fluorocarbon, polyhexafluoropropylene, cross-linked polyhexafluoropropylene, poly-perfluoromethylvinylether, cross-linked poly-perfluoromethylvinylether and mixtures thereof. It is to be understood that other types of fluoropolymers could potentially be used.

Exposure of the fluoropolymer layer (or film) 10 to electron beam radiation 16, as illustrated in FIG. 2, changes the molecular structure of the fluoropolymer in the patterned area(s) 20. Such changes include shortening the length of the polymeric chains such as by chain scission and thus reducing the molecular weight of the fluoropolymer. Exposure of the fluoropolymer layer (or film) 10 to electron beam radiation 16, thus allows for selective changes in the molecular structure of the fluoropolymer layer to be brought about in the patterned area 20.

The fluoropolymer layer (or film) 10 can be exposed to electron beam radiation 16 by means of a focused electron beam displaced over the surface of the fluoropolymer layer (or film) 10 following a desired pattern, commonly known in the art as electron beam lithography. Alternatively, the fluoropolymer layer (or film) 10 can be exposed to electron beam radiation 16 by means of a shaped electron beam, commonly known in the art as shaped electron beam lithography, electron projection lithography and cell projection lithography. These lithography techniques allow for resolutions as small as 5 nm to be obtained. Typical electron beam exposure doses range from about 10-100 μC/cm² at 30 KeV, or from about 15-150 μC/cm² at 50 KeV.

Following exposure, the fluoropolymer layer (or film) 10 comprising a patterned area 20 is developed by contacting it with a solution including alkaline salts of arenethiolates dissolved in a dipolar aprotic solvent. Examples of polar aprotic solvent include DMSO, DMF, DMA, CH₃CN, CH₃NO₂, HMPA, 1-methyl-2-pyrrolidinone, N,N-dimethylpropionamide, N,N-dimethylacetamide, N,N-diethylacetamide, propylene carbonate, acetone and combinations thereof. Of course, it is to be understood that all of these solvents are to be used in the liquid state. The relative inability of dipolar aprotic solvents to interact (solvate) effectively with anions results in very large rate accelerations relative to protic solvents which are capable of solvating both cations and anions. The non-solvated anions react via nucleophilic substitution reactions with the shortened fluoropolymer chains, to effect substitutions of fluorine atoms. These substitutions of fluorine atoms on the shortened fluoropolymer chains produce derivatives that more readily dissolve in the developing solution. Therefore, the patterned area(s) 20 dissolve selectively faster in the developing solution, leaving the less soluble unexposed areas 22 of the fluoropolymer layer (or film) 10 on the surface of the substrate 14. The fluoropolymer layer (or film) 10 is thus patterned in a positive manner.

Different chemical, physical and physico-chemical transfer processes can be used to transfer the pattern formed as a result of the removal of the patterned area(s) 20 form the fluoropolymer layer (or film) 10 (FIG. 4) to the substrate (14) or to a part thereof. Fluoropolymers being chemically stable molecules, the fluoropolymer layer (or film) 10 is sufficiently resilient to the transfer processes to allow for adequate transfer of the pattern to the substrate without significant loss of resolution.

The invention will now be further illustrated by the following non-limitative examples:

### EXAMPLE 1

The manufacture of nano-structures for bio-technology related application often requires the patterning of highly hydrophobic surfaces. Fluoropolymers are well known in the relevant art for their hydrophobic nature. Given a substrate of hydrophilic glass coated with a 500 nm thick layer of perfluoroalkoxy polymer resin, the resin is then exposed to an electron beam lithography system to expose a pattern on the resin. The electron beam is displaced selectively in some areas to produce patterns of exposed areas. In the exposed areas, the molecular structure of the perfluoroalkoxy polymer resin is modified by the braking of a plurality of chemical bonds resulting in a resin comprising shortened perfluoroalkoxy polymer chains. The electron beam current is 150 pA and the radiation energy is 50 KeV. The exposure dose is on average 30 μC/cm².

Following electron beam lithography, the patterned perfluoroalkoxy polymer resin layer is spin-sprayed at 20° C. over a period of one minute with a sodium salt solution of benzenethiol in 1-methyl-2-pyrrolidone at a concentration of 0.005 mol/L. The patterned areas of the perfluoroalkoxy polymer resin layer will dissolve more readily in the developing solution. Following spin-spraying, the patterned areas of the perfluoroalkoxy polymer resin layer are completely removed from the surface of glass substrate, while the unexposed areas will have remained essentially intact having maintained most of their initial thickness. The substrate is then rinsed using de-ionized water in order to remove any remaining sodium salt solution as well as any reaction by-products from the surface. Following drying using nitrogen, a hydrophilic glass plate comprising a patterned perfluoroalkoxy polymer resin layer is obtained.

### EXAMPLE 2

Electron beam lithography is the most common method used to pattern high resolution features on photomasks used in conventional photolithography. The resolution in electron-beam lithography is theoretically only limited by the ultimate resolution of the radiation (i.e. electron) sensitive resist used for pattern transfer to the photomask blank. Currently, the photolithography industry is broadly using wavelengths of 193 nm and 157 nm respectively for microelectronic applications, while photomask feature sizes required for the fabrication of dense and complex patterns are approaching ¼ of the used wavelength. As discussed hereinabove, most of the currently available resists use photo-induced acid generators to enhance the sensitivity of the resist polymer(s) to the radiation (i.e. electrons). Their resolution is therefore dependent on the extend of acid generated diffusion throughout the resist polymer(s). The following non-limitative example is described with reference to FIGS. 5a-5e and illustrates how the method of the present invention can be used to overcome the resolution limitation characteristic of the current state of the art.

As illustrated in FIG. 5a, a clean photomask blank comprising a 20 nm thick layer of chromium 50 deposited on a surface 51 of a square quartz plate 52 (152 nm in side lengths and 5 mm in thickness) is provided. The photomask blank is inserted into a barrel-shaped plasma chamber having parallel electrodes above and underneath the photomask blank, which resides in a flat position within the plasma chamber. The plasma chamber is then connected to a vacuum pump and subsequently filled with a pressure of CHF₃ (20-30 minutes at about 0.1 Torr). Of course, an increase in pressure will result in reduced reaction times. Inversely, a decrease in pressure will result in longer reaction times. This is believed to be within the ability of one of ordinary skill in the art to determine the operating conditions. Radio-frequency electrical excitation (100 W) is then used to create a plasma between the two electrodes, ionizing the gas in the plasma chamber with the concomitant chemical reactions. Among the chemical reactions, there is the formation of tetrafluoroethylene, a non-volatile compound capable of polymerization.

While under plasma excitation, a layer of polymer 53 (FIG. 5a) comprising mainly poly-tetrafluoroethylene is deposited over the surface of the chromium layer 50 (FIG. 5a). When the fluoropolymer layer 53 (FIG. 5a) reaches a thickness of 100 nm, the plasma reaction is stopped and the plate is removed from the plasma chamber. The plate is then exposed to an electron beam lithography system to expose a pattern 54 (FIG. 5b) on the fluoropolymer layer 53 (FIG. 5b). A focused electron beam 55 (FIG. 5b) is displaced selectively over some area(s) of the surface of the fluoropolymer layer using computer controlled coils to reproduce a pattern 54 (FIG. 5b) from a CAD file. In the exposed areas, the molecular structure of the fluoropolymer layer is modified by the braking of a plurality of chemical bonds resulting in a layer comprising shortened polymeric chains. The focused electron beam current is 150 pA and the radiation energy of 30 KeV. The exposure dose is on average 20 μC/cm².

Following electron beam lithography, the patterned fluoropolymer layer is developed at 20° C. over a period of one minute with a sodium salt solution of benzenethiol in 1-methyl-2-pyrrolidone at a concentration of 0.005 mol/L (FIG. 5c). The patterned area(s) of the fluoropolymer layer will dissolve more readily in the developing solution. Following exposure to the developing solution, the patterned area(s) of the fluoropolymer layer 53 (FIG. 5c) are completely removed from the surface of the photomask blank, while the unexposed area(s) 56 (FIG. 5c) will have remained essentially intact having maintained a thickness in excess of 60 nm. The patterned photomask blank is then rinsed using de-ionized water in order to remove any remaining sodium salt solution as well as any reaction by-products from the surface and dried using nitrogen.

The dried patterned photomask blank is then exposed to a plasma etching system such as inductively coupled plasma (ICP) etching, to transfer the pattern from the fluoropolymer resist 53 (FIG. 5d) to the chromium layer 50 (FIG. 5d). This can be achieved, for example, using a Cl₂:O₂ (10:1) gas mixture. The fluoropolymer layer 53 (FIG. 5d) being chemically resistant to Cl₂, only a small amount of this layer will be removed during the plasma etching process, while all of the exposed area(s) (i.e. chromium exposed area(s)) will be completely removed from the quartz plate.

The patterned quartz plate (i.e. photomask) can be further treated with an O₂ plasma to completely remove the fluoropolymer resist from its surface, without damaging any of the underlying residual chromium layer 50 (FIG. 5e) or the quartz plate 52 (FIG. 5e). The pattern is thus transferred from the fluoropolymer resist to the chromium layer, making the photomask suitable for photolithographic applications.

It is to be understood that the invention is not limited in its application to the details of construction and parts illustrated in the accompanying drawings and described hereinabove. The invention is capable of other embodiments and of being practiced in various ways. It is also understood that the phraseology or terminology used herein is for the purpose of description and not limitation. Hence, although the present invention has been described hereinabove by way of preferred embodiments thereof, it can be modified, without departing from the spirit, scope and nature of the subject invention as defined in the appended claims.

What is claimed is:

1. A process for producing a pattern in a radiation sensitive fluoropolymer resist, comprising:
(a) depositing a layer of the radiation sensitive fluoropolymer resist on a face of a substrate;
(b) exposing the radiation sensitive fluoropolymer resist to an electron beam to define the pattern, the resist then having an exposed fluoropolymer resist area defining the pattern and an unexposed fluoropolymer resist area; and
(c) removing the exposed fluoropolymer resist area by contacting the radiation sensitive fluoropolymer resist with an alkaline polar aprotic solvent system leaving the unexposed fluoropolymer resist area on the substrate.

2. The process according to claim 1, wherein exposing the radiation sensitive fluoropolymer resist to define the pattern comprises using a technique selected from the group consisting of focussed electron beam lithography, shaped electron beam lithography, electron projection lithography and cell projection lithography.

3. The process according to claim 1, wherein the electron beam has a radiation dose ranging from about 0.5 μC/cm² to about 1000 μC/cm².

4. The process according to claim 3, wherein the electron beam has a radiation energy ranging from about 1 KeV to about 200 KeV.

5. The process according to claim 1, wherein the radiation sensitive fluoropolymer resist is selected from the group consisting of poly-fluorotetraethylene, cross-linked poly-fluorotetraethylene, polyvinyl fluoride, cross-linked polyvinyl fluoride, polyvinylidene fluoride, cross-linked polyvinylidene fluoride, poly-perfluoroalkoxy fluorocarbon, cross-linked poly-perfluoroalkoxy fluorocarbon, polyhexafluoropropylene, cross-linked polyhexafluoropropylene, poly-perfluoromethylvinylether, cross-linked poly-perfluoromethylvinylether and mixtures thereof.

6. The process according to claim 1, wherein the polar aprotic solvent system is selected from the group consisting of DMSO, DMF, DMA, CH₃CN, CH₃NO₂, HMPA, 1-methyl-2-pyrrolidinone, N,N-dimethylpropionamide, N,N-dimethylacetamide, N,N-diethylacetamide, propylene carbonate, acetone and combinations thereof.

7. The process according to claim 1, wherein the polar aprotic solvent system has a dielectric constant of at least 20.

8. The process according to claim 1, wherein the polar aprotic solvent system comprises alkaline salts of arenethiolates.

9. The process according to claim 8, wherein the arenethiolates are selected from the group consisting of lithium-benzenethiolate, sodium-benzenethiolate, potassium-benzenethiolate, lithium-4-methylbenzenethiolate, lithium-4-methoxybenzenethiolate, sodium-4-methylbenzenethiolate, sodium-4-methoxybenzenethiolate, potassium-4-methylbenzenethiolate, potassium-4-methoxybenzenethiolate and combinations thereof.

10. The process according to claim 1, wherein depositing a layer of the radiation sensitive fluoropolymer resist comprises using plasma polymerization of at least one fluorine containing gas.

11. The process according to claim 10, wherein the fluorine containing gas is selected from the group consisting of CF₄, C₂F₄, C₂F₆, C₃F₆, C₃F₈, C₄F₈, CHF₃, CH₂F₂, combinations of the foregoing and combinations of the foregoing with another gas.

12. The process according to claim 11, wherein the other gas is selected from the group consisting of CH₄, H₂, He, N₂ and O₂.

13. The process according to claim 1, wherein the substrate is selected from the group consisting of imprint lithography template blanks, photomask blanks and semiconductor materials.

14. The process according to claim 13, wherein the semiconductor materials are selected from the group consisting of gallium arsenide, gallium antimonite, silicon, silicon carbide, germanium, silicium germanium, InAs, InGaAs, and InP.

15. The process according to claim 13, wherein the photomask blanks comprise a layer selected from the group consisting of chromium layer, molybdenum-silicium layer and molybdenum-silicide layer, deposited on a surface of a glass plate or a quartz plate.

16. The process according to claim 13, wherein the imprint lithography template blanks comprise a chromium layer deposited on a surface of a glass plate, a glass wafer or a quartz plate.

17. The process according to claim 1, wherein exposing the radiation sensitive fluoropolymer resist to an electron beam comprises changing the molecular structure of the fluoropolymer in the exposed fluoropolymer resist area.

18. The process according to claim 17, wherein changing the molecular structure of the fluoropolymer comprises breaking chemical bonds between atoms of the fluoropolymer in the exposed fluoropolymer area to define the pattern, exposing the radiation sensitive fluoropolymer resist to an electron beam to define the pattern.
